(19) United States
(12) Patent Application Publication
(10) Pub. No.: US 2009/0123625 A1
(43) Pub. Date: May 14, 2009

(54) PAN FOR BAKING

(75) Inventor: Kingsley SHANNON, Alpharetta, GA (US)

Correspondence Address: FOLEY AND LARDNER LLP;SUITE 500, 3000 K STREET NW, WASHINGTON, DC, 20007, US

(73) Assignee: Calphalon Corporation

(21) Appl. No.: 12/185,532

(22) Filed: Aug. 4, 2008

Related U.S. Application Data
(63) Continuation-in-part of application No. 29/297,532, filed on Nov. 13, 2007, now Pat. No. D574182.

(51) Int. Cl. A21B 3/13; A47J 37/01; A21B 5/00; A23L 1/01

(52) U.S. Cl. 426/523; 99/426; 249/111; 249/119; 426/391

(57) ABSTRACT

A pan is for making baked products. The pan comprises an upper surface and a plurality of receptacles for receiving batter. Each receptacle has one or more side walls extending from a bottom wall to the upper surface. Each receptacle is configured to cause a product baked therein to be crispy around the entire periphery of the product

### BACKGROUND

This application is a continuation-in-part of U.S. Design application Ser. No. 29/297,532, which has a U.S. filing date of Nov. 13, 2007, which is incorporated herein by reference in its entirety.

The present invention relates to a pan for making baked goods, such as bar-shaped dessert products, for example, brownies.

Currently, bakers typically make bar-shaped desserts by baking the batter or baking material in a 9″×13″ cake pan, and then cut the resulting baked good into smaller sections.

### SUMMARY

According to one embodiment of the present invention, a pan for making baked goods is provided. According to one embodiment, the pan comprises an upper surface and a plurality of receptacles for receiving batter. Each receptacle has one or more side walls extending from a bottom wall to the upper surface. Each receptacle is configured to cause a product baked therein to be crispy around the entire periphery of the product

According to another embodiment of the present invention, a method of making baked goods is disclosed. According to one embodiment, the method comprises: providing a baking pan, wherein the baking pan comprises an upper surface and a plurality of receptacles, wherein each receptacle has one or more side walls extending from a bottom wall to the upper surface; filling at least one of the receptacles with a batter; and baking the batter such that a product baked in the at least one receptacle is crispy around the entire periphery of the baked product which is caused by the baking.

It is to be understood that both the foregoing general description and the following detailed description are exemplary and explanatory only, and are not restrictive of the invention as claimed.

### BRIEF DESCRIPTION OF THE DRAWINGS

The features, aspects, and advantages of the present invention will become apparent from the following description, appended claims, and accompanying exemplary embodiments shown in the drawings, which are briefly described below.

FIG. 1 is a top frontal perspective view of a baking pan according to one embodiment of the present invention.

FIG. 2 is a front view of the baking pan shown in FIG. 1

FIG. 3 is a rear view of the baking pan shown in FIG. 1.

FIG. 4 is a left side view of the baking pan shown in FIG. 1

FIG. 5 is a right side view of the baking pan shown in FIG. 1.

FIG. 6 is a top view of the baking pan shown in FIG. 1.

FIG. 7 is a bottom view of the baking pan shown in FIG. 1.

FIG. 8 is a top frontal perspective view of a baking pan according to another embodiment of the present invention.

FIG. 9 is a top frontal perspective view of a baking pan according to another embodiment of the present invention.

FIG. 10 is a top frontal perspective view of a baking pan according to another embodiment of the present invention.

FIG. 11 is partial cross section of the baking pan taken along line XI-XI in FIG. 6.

FIG. 12 is a top frontal perspective view of a bar-shaped baked good formed using the baking pan according to an embodiment of the present invention.

FIG. 13 shows a partial cross section of the connection between the receptacle and the upper surface taken along line XIII-XIII in FIG. 6.

FIG. 14 shows a partial cross section of an alternative embodiment of the connection between the receptacle and the upper surface.

### DETAILED DESCRIPTION

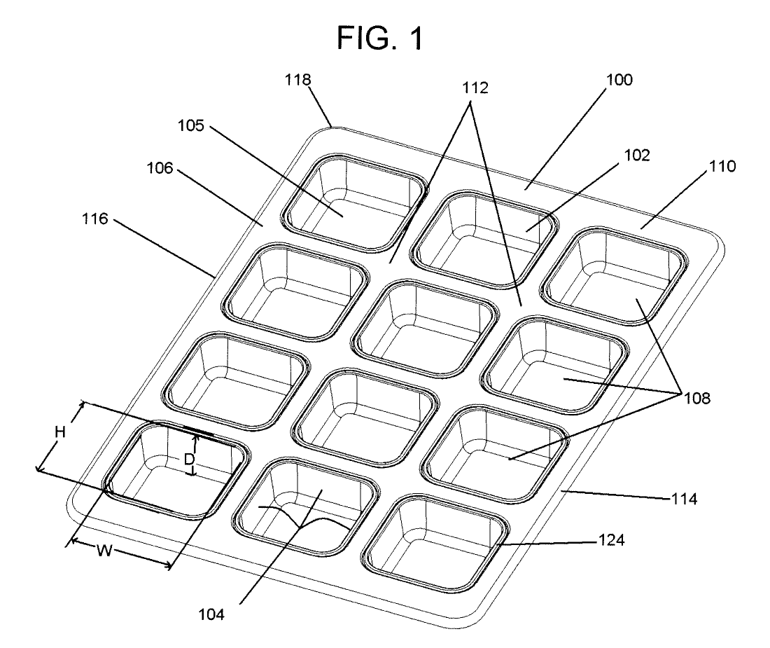

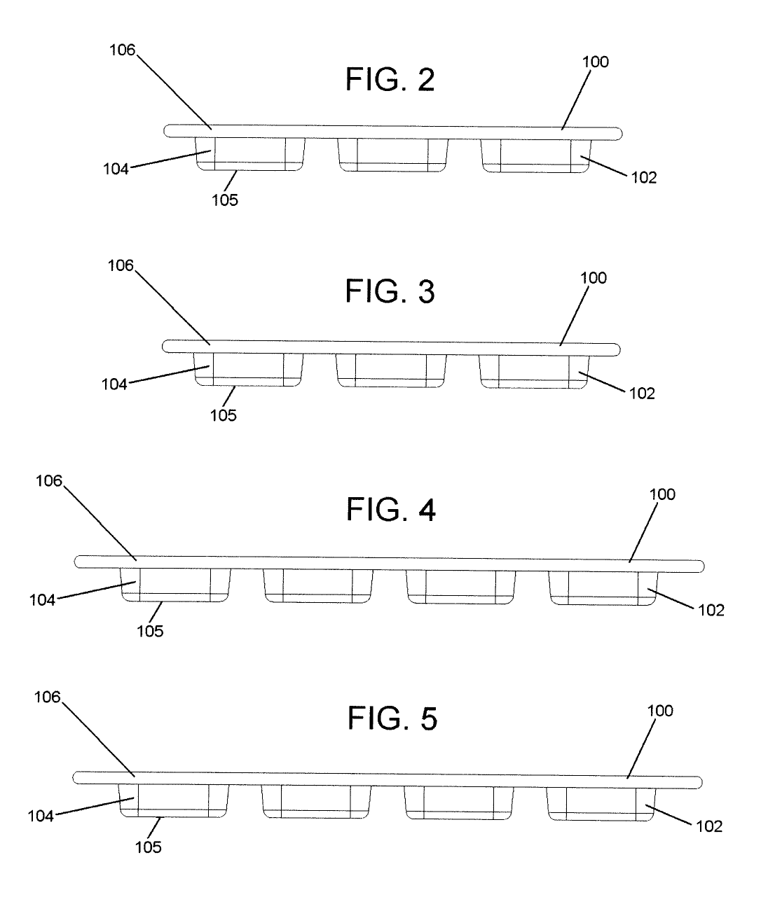

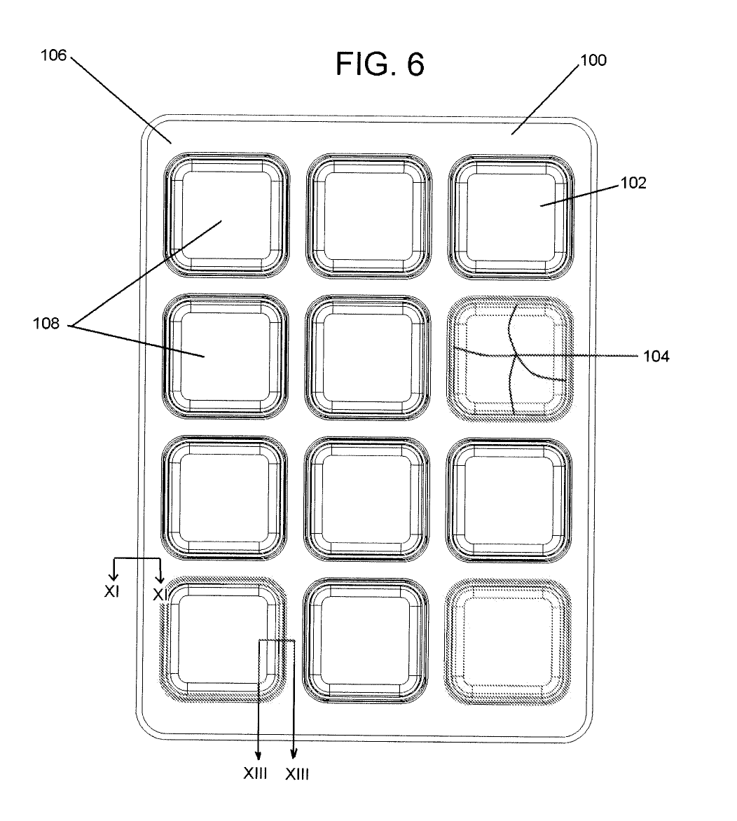

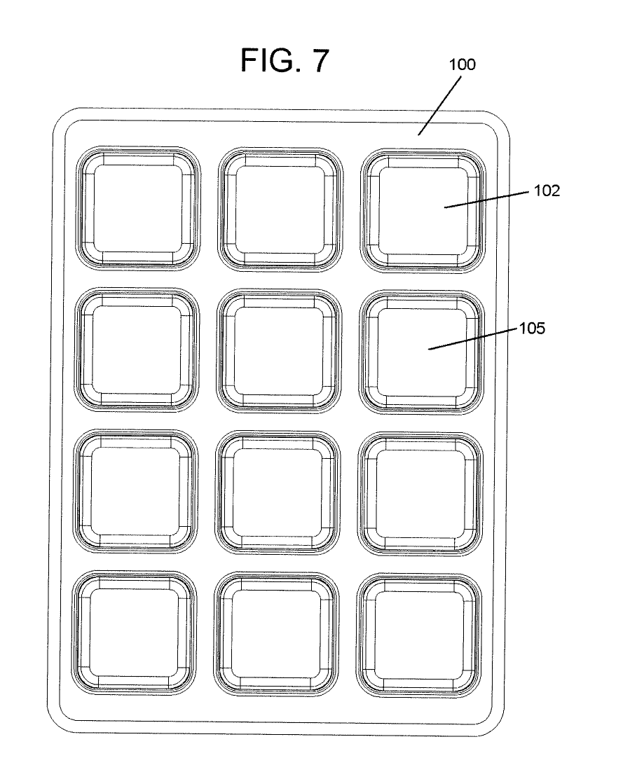

Embodiments of the present invention will now be described with reference to the drawings. FIGS. 1-7 shows a baking pan 100 according to an embodiment of the present invention in which FIG. 1 is a top frontal perspective view, FIG. 2 is a front view, FIG. 3 is a rear view, FIG. 4 is a left side view, FIG. 5 is a right side view, FIG. 6 is a top view, and FIG. 7 is a bottom view.

The baking pan 100 of FIGS. 1-7 comprises a plurality of receptacles 102 for receiving food products, for example batter for making muffins, dessert bars, brownies or other baked products or goods. Each receptacle has one or more side walls 104 extending from a bottom wall 105 of each receptacle 102 to a common upper surface 106. In this embodiment, the bottom wall 105 and the side walls 104 form square-shaped cavities 108 (square-shaped as viewed from the top the baking pan) in which batter or other baking material can be contained. The square-shaped cavities 108 can make bar-shaped baked goods efficiently. In contrast, users, such as bakers, typically make bar-shaped desserts by baking the batter or baking material in a 9″×13″ cake pan, and then cut the resulting baked good into smaller, square sections. The square-shaped cavities permit the user to fill each square cavity and have pre-made baked products as finished baked goods. Because each individual baked good, such as a brownie, is provided in its own square-shaped cavity, the net outer surface of the resulting goods is increased, resulting in multiple crispy edges around the periphery of the baked goods.

In addition, the individual receptacles avoids waste because it permits the user to only make the number of baked goods that is desired if the desired number of baked goods is less than that made from the 9″×13″ cake pan.

In the embodiment shown in FIGS. 1-7, each receptacle may have a rectilinear or square shape as viewed from a top of the baking pan. Each receptacle may have a depth D of about 15 mm to about 35 mm, a height H of about 50 mm to about 70 mm, and a width W of about 50 mm to about 70 mm. The preferred dimensions of each receptacle are a depth D of about 25.4 mm, a height H of about 62.62 mm, and a width of about 62.62 mm. Of course, any suitable dimensions for the depth, height, and width can be used.

According to one embodiment of the present invention, each receptacle is formed separately from the upper surface and attached to the upper surface by a fastening mechanism. This action is performed by providing an upper surface with a plurality of apertures in which each aperture is sized to receive an individual receptacle. As seen in FIG. 1, each receptacle 102 is attached by crimping the upper rim 124 of the receptacle 102 around a mating location on the upper surface 106. FIG. 13 shows a partial cross section of the connection between a receptacle and the upper surface.

FIG. 13 shows the upper surface 106 having an aperture 130 in which the receptacle 102 is inserted. The upper rim 124 of the receptacle 102 includes a groove 126 at its underside which engages a mating protrusion 128 protruding from the upper surface 106. A crimping operation is then performed to pinch the ends of the groove 126 together around the protrusion 128 to join the receptacle to the upper surface. The crimping operation may take other forms as well, such as the upper surface 106 having the groove 126 while the receptacle has the mating protrusion 128, as seen in FIG. 14. Also, other fastening mechanisms may be used to fasten the receptacle to the upper surface, such as by brazing, welding, and/or press-fitting, in addition to or alternative to the crimping. According to yet another embodiment of the present invention, the receptacles 102 may be formed integrally with the upper surface 106.

The common upper surface 106 is shown to be rectangular from the top and perspective views. However, the upper surface 106 may be any suitable shape, such as square, rectangular, triangular, oval, circular, or the like. The upper surface is substantially flat on its top surface 110. The upper surface comprises a connecting portion 112 which is interspersed among the receptacles 102 and a rim portion 114 around the periphery of the connecting portion. The rim portion 114 may comprise one or more curved edges 116 and one or more curved corners 118. FIG. 11 is partial cross section of the baking pan taken along line XI-XI in FIG. 6 at an edge of the upper surface. As seen in FIG. 11, the edge 116 is formed by having the top surface 110 of the upper surface 106 curve downwards into a downward arc 120 that circles around until it contacts the underside 122 of the upper surface 106. The corners 118 may be similarly formed. One or more handle portions (not shown) can be attached to or integrally formed with the upper surface 106 at the rim portion 114 at the edges 116 and/or the corners 118.

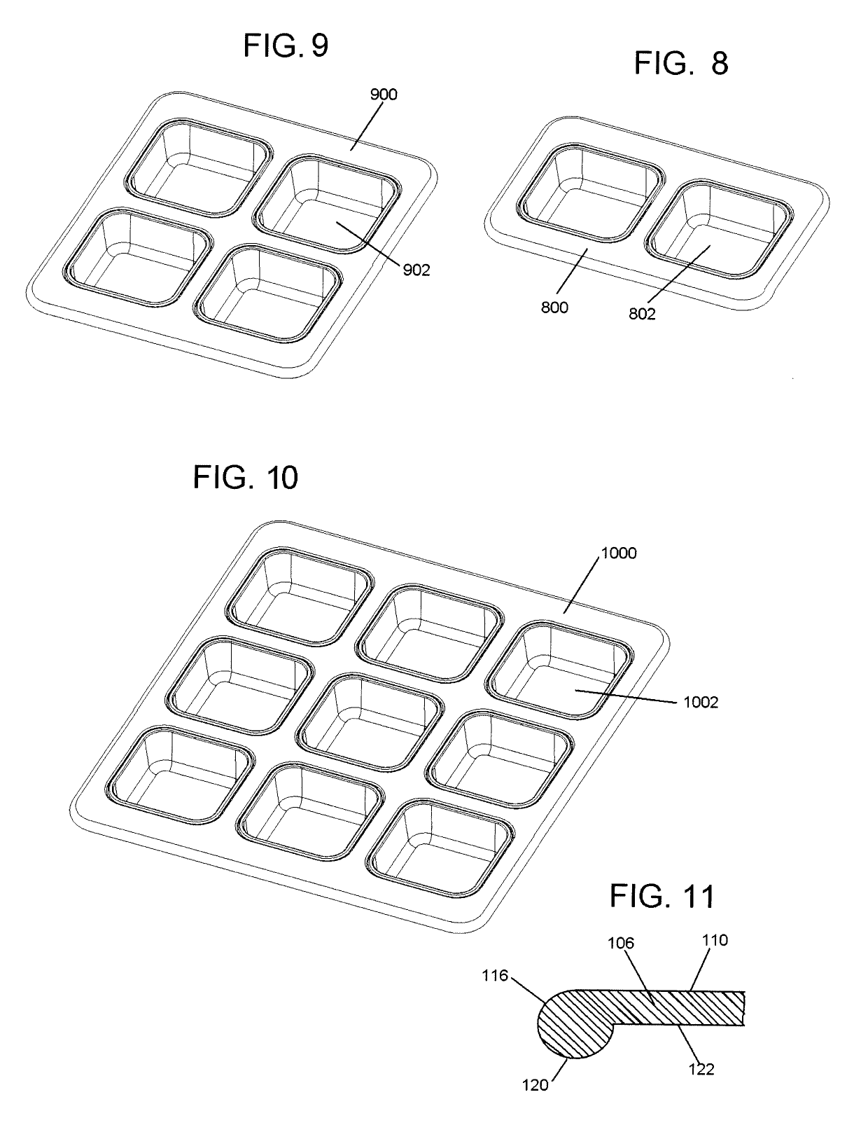

The above description of FIGS. 1-7 relates to a baking pan that has twelve receptacles. However, any number of receptacles may be used, such as one, two, three, four, or more. For example, FIG. 8 shows a baking pan 800 with two receptacles 802, FIG. 9 shows a baking pan 900 with four receptacles 902, and FIG. 10 shows a baking pan 1000 with nine receptacles 1002. According to one embodiment of the present invention, the number of receptacles may range from about 2 to about 24.

Additionally, the shape of the receptacle may be any suitable shape. For example, the proportion of the square cavity of the receptacle may be altered such that is has a rectilinear shape as viewed from the top of the baking pan, or the depth of the cavity of the receptacle may be increased or decreased while keeping the square cavity shape. In addition, the shape of the receptacles may be oval, triangular, trapezoid, circular, or any other suitable shape as viewed from the top of the baking pan.

The baking pan including the upper surface and receptacles may be made from any suitable material, such as aluminized steel, carbon steel, aluminum, other formable metals, and silicone. The materials may be formed by casting, stamping, molding or any other suitable process.

With the above baking pan, the following method of making baked goods may be conducted. The method of making a baked goods may comprise providing a baking pan such as any of the embodiments disclosed herein. For example, the baking pan may comprises an upper surface and a plurality of receptacles for receiving batter, wherein the receptacles each has one or more side walls extending from a bottom wall to the upper surface. Each receptacle may have a rectilinear, square, trapezoidal, oval, triangular, or circular shape as viewed from the top of the baking pan. Also, the number of receptacles may range from about 2 to about 24.

Next, a user may fill at least one of the receptacles with a batter. The batter may a brownie mix, resulting in a baked product that is a brownie. Other types of well known batter may be used as well. For example, the batter may be any dessert product batter used to bake a specific kind of dessert product that is typically bar-shaped or non-bar-shaped. Of course, more receptacles may be filled with the batter. For example, at least two of the receptacles may be filled with the batter to produce at least two baked products, or the number of receptacles filled with the batter is three or more to produce a corresponding number of baked goods.

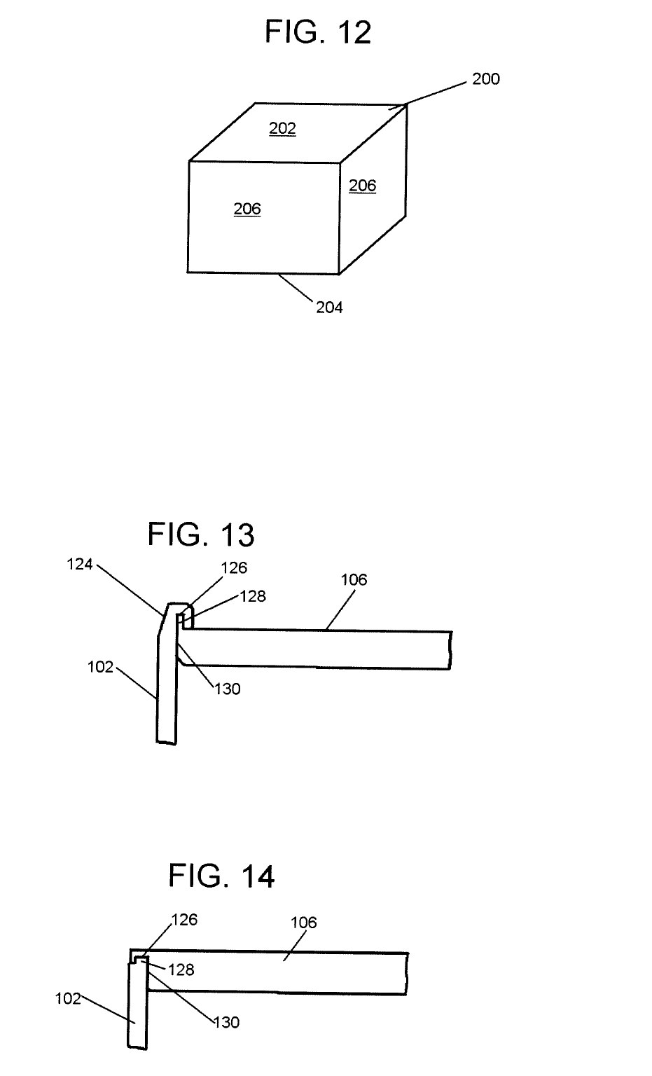

Later, the batter is baked such that the baked product is crispy around the entire periphery of the baked product caused by the baking. This is accomplished by each receptacle being configured to cause a baked good, such as a brownie, to have a crispy edge around the entire periphery of the baked product due to the size and shape of the receptacles and the periphery of the baked product being in contact with the side(s) of the receptacle. To be crispy around the entire periphery of the goods means that the entire periphery of the good is more firm than its interior. For example, the product 200 of FIG. 12 shows a periphery comprising four side walls 206 spanning between an upper surface 202 and a lower surface 204. According to one embodiment of the present invention, the outer periphery of the product is more crunchy (i.e., makes more of a crunching sound when chewed or pressed) than the interior of the baked product that the periphery encircles.

The size and shape of the receptacles also permits a more consistent heating of the product batter, such as a brownie mix, so as to permit a consistent firmness throughout the interior of the baked product. Thus, the situation in which the edges of the baked product are crispy but the center of the product is “gooey” or too soft (such as the case when the product is made in a large 9″×13″ pan and then cut up) is avoided.

Given the disclosure of the present invention, one versed in the art would appreciate that there may be other embodiments and modifications within the scope and sprit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A pan for making baked products comprising:
an upper surface; and
a plurality of receptacles for receiving batter,
wherein each receptacle has one or more side walls extending from a bottom wall to the upper surface; and
wherein each receptacle is configured to cause a product baked therein to be crispy around the entire periphery of the product.

2. The pan according to claim 1, wherein each receptacle has a rectilinear or square shape as viewed from a top of the pan.

3. The pan according to claim 2, wherein each receptacle has a depth of about 15 mm to about 35 mm, a height of about 50 mm to about 70 mm, and a width of about 50 mm to about 70 mm.

4. The pan according to claim 1, wherein the number of receptacles ranges from about 2 to about 24.

5. The pan according to claim 1, wherein each receptacle is configured to cause a brownie to have a crispy edge around the entire periphery of the brownie.

6. The pan according to claim 1, wherein each receptacle is formed separately from the upper surface and attached to the upper surface by a fastening mechanism.

7. The pan according to claim 6, wherein the fastening mechanism is one of brazing, welding, press-fitting, and crimping.

8. The pan according to claim 1, wherein each receptacle is configured to cause the entire periphery of the baked product to be more firm than the interior of the baked product that the periphery of the baked product encircles.

9. The pan according to claim 1, wherein each receptacle is configured to cause the entire periphery of the baked product to be make more of a crunching sound when chewed or pressed than the interior of the baked product that the periphery of the baked product encircles.

10. The pan according to claim 1, wherein the baked product is bar-shaped.

11. The pan according to claim 10, wherein the baked product is a bar-shaped dessert product.

12. A method of making baked goods comprising:
providing a baking pan, wherein the baking pan comprises an upper surface and a plurality of receptacles, wherein each receptacle has one or more side walls extending from a bottom wall to the upper surface;
filling at least one of the receptacles with a batter; and
baking the batter such that a product baked in the at least one receptacle is crispy around the entire periphery of the baked product which is caused by the baking.

13. The method according to claim 12, wherein each receptacle has a rectilinear or square shape as viewed from a top of the baking pan.

14. The method according to claim 13, wherein each receptacle has a depth of about 15 mm to about 35 mm, a height of about 50 mm to about 70 mm, and a width of about 50 mm to about 70 mm.

15. The method according to claim 12, wherein the number of receptacles ranges from about 2 to about 24.

16. The method according to claim 12, wherein the batter is a brownie mix, and the baked product is a brownie.

17. The method according to claim 12, wherein the number of receptacles filled with the batter is three or more to produce a corresponding number of baked products.

18. The method according to claim 12, wherein the batter is baked such that the entire periphery of the baked product is more firm than the interior of the baked product that the periphery of baked product encircles.

19. The method according to claim 12, wherein the batter is baked such that the entire periphery of the baked product makes more of a crunching sound when chewed or pressed than the interior of the baked product that the periphery of the baked product encircles.

20. The method according to claim 12, wherein the baked product is bar-shaped.

21. The method according to claim 12, wherein the baked product is a bar-shaped dessert product.
